(19) United States
(12) Patent Application Publication
(10) Pub. No.: US 2007/0156769 A1
(43) Pub. Date: Jul. 5, 2007

(54) PARTITION ELIMINATION SYSTEM FOR A DATABASE THAT USES A MULTI-LEVEL PARTITIONING DEFINITION

(75) Inventor: Paul Sinclair, Manhattan Beach, CA (US)

Correspondence Address: James M. Stover;Intellectual Property Section, Law Department, NCR Corporation, 1700 South Patterson Blvd., Dayton, OH, 45479-0001, US

(73) Assignee: NCR Corporation, Dayton, OH (US)

(21) Appl. No.: 11/563,287

(22) Filed: Nov. 27, 2006

Related U.S. Application Data
(60) Provisional application No. 60/741,396, filed on Dec. 1, 2005.

(51) Int. Cl. G06F 17/30

(52) U.S. Cl. 707/200

(57) ABSTRACT

A partition elimination system is provided for a database. The database uses a multi-level partitioning definition. The partition elimination system includes an interface for receiving data indicative of a plurality of level-specific elimination lists. Each list is respectively associated with one of the levels in the definition. A processor is responsive to the data for providing a single combined partition elimination list. Typically the level-specific elimination lists provide a minimum selection of level-specific partition pairs and the combined partition elimination list provides a minimum selection of combined partition pairs.

### FIELD OF THE INVENTION

The present invention relates to a partition elimination system for a database that uses a multi-level partitioning definition. The invention has been primarily developed for efficient processing of a query in such a database, and will be described by reference to that application. However, the invention is by no means restricted to that field of use, and has various alternate applications.

### BACKGROUND

Any discussion of the prior art throughout the specification should in no way be considered as an admission that such prior art is widely known or forms part of common general knowledge in the field.

Partitioning typically is used in a database to facilitate the efficient processing of queries. One particular technique for partitioning makes use of a Partitioned Primary Index (PPI). A PPI allows the rows of a table in the database to be:
Hash partitioned or distributed among available access modules by the hash of the primary index of the PPI.
Partitioned on each access module.
Ordered by the hash of the primary index within a given partition.

A row is mapped to a partition based on the values of the partitioning columns in the row.

On the basis of a PPI partitioning expression, and a query having constraints on the partitioning columns, it is known to perform partition elimination. Partition elimination is a process for identifying those partitions that need to be accessed to execute the relevant query. The database is able to use this information to improve the efficiency with which the query is processed. The result of a partition elimination process is typically provided in the form of an elimination list including one or more partition pairs. This list can be either an inclusion list or an exclusion list.

A PPI is optionally extended to multiple levels, becoming a multi-level PPI. This is discussed in U.S. Pat. No. 6,845,375, entitled “Multi-level Partitioned Database System”. In simple terms, a multi-level partitioning definition is implemented in the database such that rows of a table are able to be:
Hash partitioned or distributed among available access modules the hash of the primary index of the PPI.
Partitioned on each access module by a first level partitioning expression and then partitioned within each of those partitions by an underlying level partition expression, and so on.
Ordered by the hash of the primary index within the lowest level partitions.

A multi-level partitioning definition is preferably defined in terms of a combined partitioning expression. A row is mapped to a partition of the combined partitioning expression based on the values of the partitioning columns in the row.

Where a multi-level partitioning definition is used, there are typically a considerable number of possible combined partitions. More particularly, where there are Dᵢ partitions at a level “i”, and “n” levels in total, the total number of combined partitions is D₁*D₂*D₃* . . . *Dₙ. This large number of possible combined partitions affects the efficiency of a multi-level partitioning definition.

### SUMMARY

It is an object of the present invention to overcome or ameliorate at least one of the disadvantages of the prior art, or to provide a useful alternative.

In accordance with a first aspect of the invention, there is provided a partition elimination system for a database that uses a multi-level partitioning definition, the system including:
an interface for receiving data indicative of a plurality of level-specific elimination lists respectively associated with each level in the definition; and
a processor responsive to the data for providing a single combined partition elimination list.

Preferably the data is derived from partition elimination on the basis of a query that constrains on one or more level-specific partitions of the database. More preferably each level-specific elimination list identifies one or more level-specific partitions on which the query constrains. Even more preferably the combined partition elimination list identifies one or more combined partitions on which the query effectively constrains.

In some embodiments either or both of the level-specific elimination lists and the single combined partition elimination list is an inclusive list. In other embodiments either or both is an exclusive list.

Preferably for each level-specific partition in the definition there is defined a level-specific partition number and for each combination of individual partitions there is defined a combined partition number. More preferably the combined partition number is defined on the basis of a predetermined protocol. In a preferred embodiment the predetermined protocol involves identifying combinations of the level-specific partition numbers and assigning in a logical order a unique combined partition number for each combination. Typically, a unique combination of level-specific partition numbers is mappable to a unique combined partition number. In preferred embodiment the combinations are identified in increasing combined partition order.

Preferably the processor repeatedly calls a function to identify a pair of combined partitions for inclusion in the combined elimination list, the pair defining a range of combined partitions. The function is preferably responsive to function state data. More preferably the function modifies the function state data such that a unique result is provided each time the function is called, the unique result either being a unique pair for inclusion in the combined elimination list or a null result indicating that all unique pairs for inclusion in the combined elimination list have been previously identified.

In a preferred embodiment the function includes an identification sub-function for identifying a unique combination of the level specific partitions identified by the level-specific elimination lists for a selection of the levels. The selection of the levels is preferably from the lowest level to the highest level for which the respective level-specific elimination list excludes one or more level-specific partitions. Preferably, each time the identification sub-function is called a unique and not previously considered combination is identified, the sub-function returning null once all unique combinations have been previously identified. In some embodiments the unique combination is maintained in the function state data.

Preferably the function includes a mapping sub-function, the mapping sub-function being responsive to the unique combination for identifying the pair of combined partitions. The mapping function is preferably responsive to the number of contiguous combined partitions for each level in the selection of levels.

Preferably the level-specific elimination lists provide a minimum selection of level-specific partition pairs and the combined elimination list provides a minimum selection of combined partition pairs. More preferably the level-specific elimination lists provide level specific pairs in increasing order, and the combined elimination list provides combined partition pairs in increasing order.

According to a second aspect of the invention, there is provided a method for partition elimination in a database, the database using a multi-level partitioning definition, the method including the steps of:
receiving data indicative of a plurality of level-specific elimination lists respectively associated with each level in the definition; and
being responsive to the data for providing a single combined partition elimination list.

According to a further aspect of the invention, there is provided a combined partition elimination list for a database that uses a multi-level partitioning definition.

### BRIEF DESCRIPTION OF THE DRAWINGS

Benefits and advantages of the present invention will become apparent to those skilled in the art to which this invention relates from the subsequent description of exemplary embodiments and the appended claims, taken in conjunction with the accompanying drawings, in which:

FIG. 1 is a schematic representation of a partition elimination system in accordance with an embodiment of the invention;

FIG. 2 is a table showing an implementation of a protocol for numerically identifying combined partitioning columns;

FIG. 3 is a flowchart illustrating a partition elimination process;

FIG. 4 is a table showing numbering of combined partitioning columns relevant to a specific example; and

FIG. 5 is a table showing a combined elimination list for a specific example.

### DETAILED DESCRIPTION

Referring to the drawings, it will be appreciated that, in the different figures, corresponding features have been denoted by corresponding reference numerals.

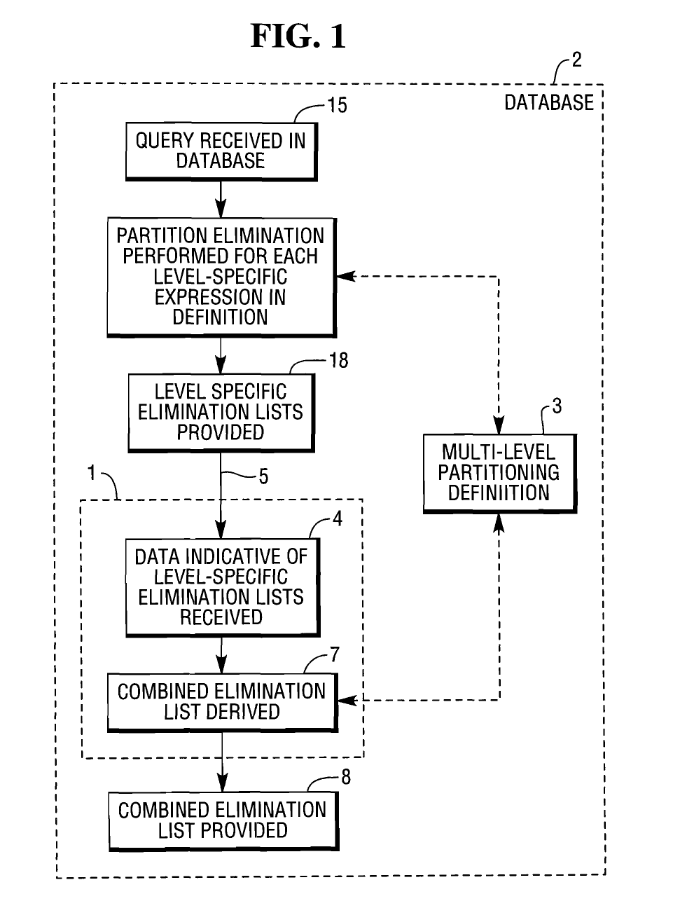

FIG. 1 illustrates a partition elimination system 1 for a database 2. Database 2 uses a multi-level partitioning definition 3. System 1 includes an interface 4 for receiving data 5 indicative of a plurality of level-specific elimination lists 6. Each list 6 is respectively associated with one of the levels in definition 3. A processor 7 is responsive to data 5 for providing a single combined partition elimination list 8.

Typically lists 6 provide a minimum selection of level-specific partition pairs and list 8 provides a minimum selection of combined partition pairs. In the present embodiment, lists 6 provide level specific pairs in increasing order, and likewise list 8 provides combined partition pairs in increasing order.

For the purpose of the present disclosure, a multi-level partitioning definition, such as definition 3, is taken to be a protocol under which a database (such as database 2) is organized using multi-level partitioned primary indexes. This definition provides a level-specific partitioning expression for a number of levels, from a lowest level to a highest level. Rows in the database are partitioned in accordance with a given level specific partitioning expression, and partitioned within that partition by the next higher partitioning expression.

The definition of a “lowest” level and a “highest” level is somewhat subjective. In the present disclosure, each level is given a numerical identifier, and highness is based on the value of this identifier. In a situation where there are N levels, Level 1 is the lowest and Level N is the highest.

Interface 4 and processor 7 are not discrete components in many embodiments. Indeed, they are often represented as embedded functionalities within the engine of database 2.

For a given query 15, there is typically only a reduced selection of the number total of partitioning column values in database 2 that require consideration when processing that query. That is, the WHERE clause of query 15 constrains only this reduced selection of the partitioning column values. The terms “partitioning column values”, “partition numbers,” and “partitions” are used interchangeably for the sake of this disclosure. Identification of these column values or partitions allows for improved query processing efficiency due to the ability to discount other partitioning column values, and therefore reduce the need to examine often large portions of data contained in database 2.

As a simple single level example, where a database is single-level partitioned by a partitioning column PC having integer partitioning column values from one to ten, and a query Q constrains on partitioning column values three to six, it is only necessary to examine partitions three to six when processing query Q. This result is typically expressed in the form of a level-specific elimination list 18. Such a list is typically expressed in the form of one or more level-specific partition number pairs (X,Y), where X and Y specify the lowest and highest level-specific partition numbers in a range. In the present example, the list could be inclusive list (3,6) or exclusive list (1,2), (7,10). Whether inclusive or exclusive lists are used in a particular case is dependant on a number of factors, such as internal database settings. However, typically the simpler of the lists is used—in this case being the inclusive list. For the purpose of this disclosure, only inclusive lists are considered. Those skilled in the art will recognize both how inclusive lists and exclusive lists are cross-converted and how the information provided is applied to situations where exclusive lists or a combination of inclusive and exclusive lists are used.

Typically, each level-specific expression is a RANGE_N function, general linear expression, or a CASE_N function, although other possibilities are considered. Optionally, the level-specific partitioning expressions are provided in the form of a combined partitioning expression. The nature of the combined expression or each level-specific expression is particularly relevant when applying level-specific partition elimination to derive level specific elimination lists. The derivation of such lists is generally beyond the scope of the present disclosure, and will be understood by those skilled in the art.

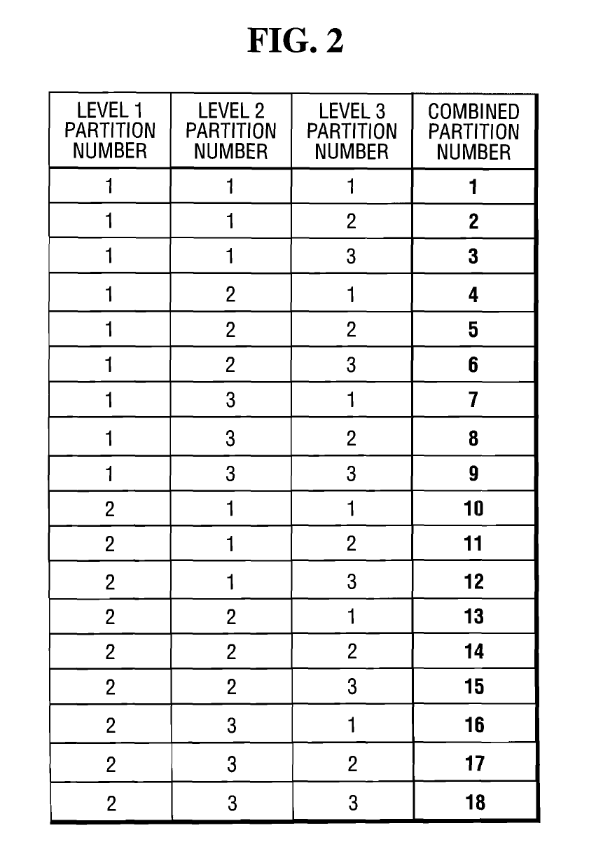

Each level-specific partitioning expression defines one or more partitions for its respective level, and these are numbered. The numbering used for level-specific partitions is not suitable for identifying combined partitions. The number of partitions for a level is referred to as its dimension. If a definition 3 is defined by a first level expression having D₁ partitions, a second level expression having D₂ partitions, and a third level expression having D₃ partitions, the resulting definition 3 has D₁*D₂*D₃ combined partitions. This is because every combination of partitioning columns results in a unique combined partition. How these combined partitions are identified varies between databases, and the manner of definition has repercussions in how system 1 is implemented, as discussed further below. For the sake of the present disclosure, each combined partition is provided a numerical identifier on the basis of a simple combinatorial protocol, as shown in FIG. 2. FIG. 2 shows the application of the protocol for a three level definition 3, the first level-specific expression having two level-specific partitions, and the second and third levels having three level-specific partitions each. This definition 3 has eighteen uniquely consecutively numbered combined partitions.

In other embodiments alternate protocols are used for identifying combined partitions. For example: non-consecutive numbering. For instance, under one protocol, combined partition 1 of FIG. 2 is identified as 1-1-1, 2 as 1-1-2, 10 as 2-1-1 and so on.

Combined list 8 identifies those combined partitions that need to be accessed for processing of query 15. This is particularly valuable given the large number of combined partitions existing under a typical definition 3

Processor 7 repeatedly calls a combined partition pair provide function 20 to accumulate individual combined partition pairs that collectively define list 8. Function 20 preferably returns null once all combined pairs have been provided. This is performed in two main stages, as described below.

The first stage involves running a sub-function 21 for identifying a unique and not previously considered combination of partitions of lists 18. Typically sub-function 21 is designed such that the unique combinations are identified in a logical order and in an efficient manner. This is primarily a matter of algorithm design, and various algorithms are used between embodiments, such as recursive and/or iterative algorithms. A specific example is provided further below.

It is typically not necessary for sub-function 21 to consider all unique and not previously considered combinations. For example, if query 15 does not constrain on one or more of the highest-level partitions, consideration of combinations reliant on those highest levels is not necessary. That is, it is known that all partitions at those levels are required for processing of query 15. To this end, an AllSubPartitions (ASP) level is defined, this being the highest level at which the level-specific elimination list 18 eliminates one or more partitions. For the sake of this disclosure, a “unique and not previously considered combination of partitions” does not include combinations reliant on partitions of levels above the ASP level.

The second stage is commenced in response to completion of sub-function 21. For example, sub-function 21 is a looped function that exits once an appropriate combination is identified, and the second stage is commenced upon the loop being exited. The second stage involves the running of a sub-function 22 for deriving a partition pair for the combination identified by sub-function 21. This involves applying a scaling factor to the combination such that an individual combined partition pair in the form of two combined partition numbers is provided. The scaling factor is selected to some extent on the basis of the protocol used for numbering combined partitions. However, the derivation is typically responsive to the number of contiguous combined partitions for each level from the lowest to the ASP level. The number of contiguous combined partitions for a given level is calculated by multiplying the number of contiguous combined partitions for the consecutively higher level by the number of partitions in the consecutively higher level. It will be appreciated that the number of contiguous combined partitions for the highest level is one.

Typically, sub-functions 21 and 22 operate in conjunction with function state data 24 for tracking the likes of partition pair numbers, the starting and ending values for a particular pair, and so on. The sub-functions are enabled to alter this data such that a unique result (or a null result) is provided each time function 20 is called.

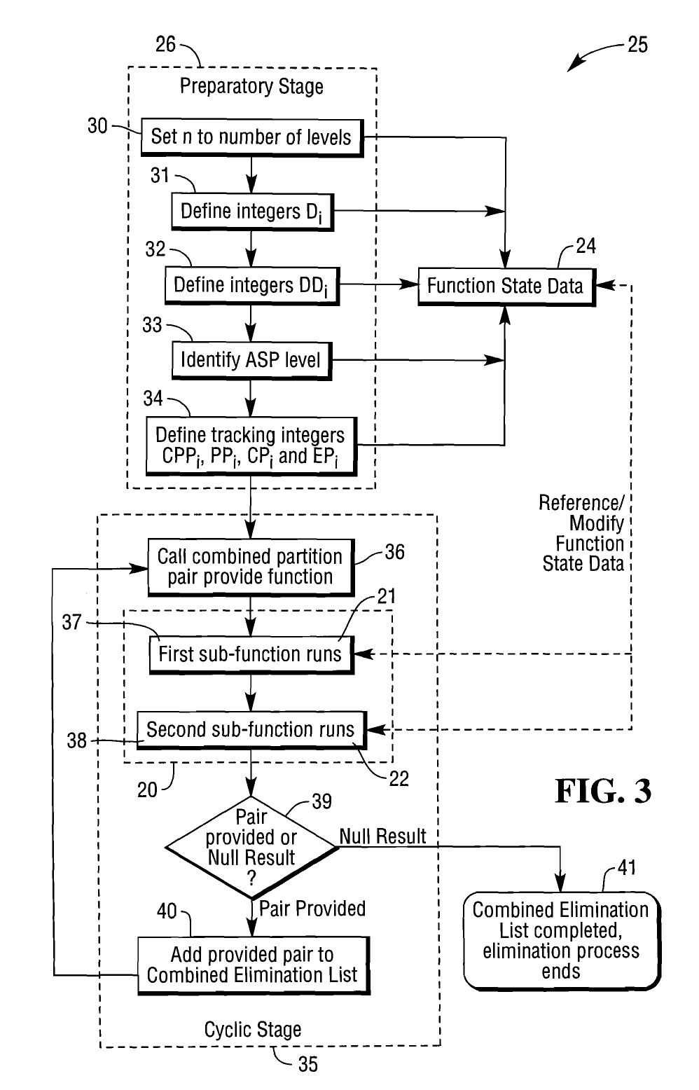

An exemplary function 20 is described below with reference to an associated set of data 24, that is, function state data. This provides a partition elimination process 25, which is described by reference to the flowchart of FIG. 3. This example should not be regarded as limiting in any way. Variable names are provided for the sake of illustration only, and alternate techniques—such as recursion—are eminently possible. Code optimizations for calculating scaling factors are varied in other examples. Further, extensions to deal with exclusion lists or inclusion/exclusion combinations are possible. To simplify, the following assumes non-empty inclusion lists for all the levels and, for at least one level, there is partition elimination (that is, for some level, not all the partitions are included). Note that in the first case, the result inclusion list would be empty and, in the second, the result inclusion list would include all combined partitions.

Process 25 commences with a preparatory phase 26, this being designed to provide initial function state data 24. To commence, “n” is set to the number of levels at 30. That is, the number of level-specific partitioning expressions. Following this, integers Dᵢ are defined for i=1 to n at 31. Dᵢ is set to the number of partitions (that is, the dimension) for the corresponding level. For example, if there are 20 partitions at level i, Dᵢ is 20. At 32, integers DDᵢ are defined for each level i=1 to n to provide the number of contiguous combined partitions at that level. Following from description above, DDₙ=1 and DDᵢ=DDᵢ₊₁*Dᵢ₊₁.

The ASP level is identified at 33. This is achieved by running a loop for i=n down to 1. If one or more partitions are eliminated by the list 18 for a level i, the loop exits and the ASP level is set to i.

At 34 a number of tracking integers are defined. These are:
Integer CPPᵢ to track the current partition number pair for that level, each initially set to 1.
Integer PPᵢ, each initially set to the number of partition number pairs for that level.
Integer CPᵢ to track the current partition number for that level, each initially set to the starting partition number of the first partition pair for that level.
Integer EPᵢ to track the ending partition number for the current partition pair for that level, each initially set to the ending partition number of the first partition pair for that level.

This completes phase 26, and provides initial function state data 24. The next phase 35 is a cyclic phase, which involves calling function 20 repeatedly until a null result is provided.

To commence phase 35, function 20 is called at 36 and sub-function 21 is run at 37. The sub-function 21 used for the sake of this example is set out below.
a. For i=ASP level down to 1,
   i. If CPᵢ<=EPᵢ, exit loop.
   ii. If CPPᵢ<PPᵢ,
      1. Add 1 to CPPᵢ.
      2. Set CPᵢ and EPᵢ to the starting and ending partition numbers, respectively, of the partition pair indicated by CPPᵢ.
      3. Exit loop.
   iii. If i=1, return null.
   iv. Set CPPᵢ to 1.
   v. Set CPᵢ and EPᵢ to the starting and ending partition numbers, respectively, of the partition pair indicated by CPPᵢ.
   vi. Add 1 to CPᵢ₋₁.

Assuming a non-null result, sub-function 22 runs at 38 once the loop of sub-function 21 is exited. The sub-function 22 used for the sake of this example is set out below.
b. Set i to ASP level.
c. If CPPᵢ=1,
   i. Set B to 1.
   ii. For k=1 to (ASP level-1), set B to B+(CPₖ−1)*DDₖ.
d. Set S to (CPᵢ−1)*DDᵢ+B.
e. Set E to EPᵢ* DDᵢ+B−1.
f. Set CPᵢ to EPᵢ+1.
g. Return partition pair (S, E).

Decision 39 considers whether a combined partition pair was provided by sub-function 22, or a null result was provided by sub-function 21. In the case of the former, partition pair (S,E) is placed in a repository at 40. Function 20 is called again at 36, and a loop is formed. Further pairs (S,E) are accumulated in the repository upon each running of function 20. This continues until sub-function 21 returns null, indicating that all pairs have been provided.

Where sub-function 21 provides a null result, sub-function 22 does not run. At decision 40 it is determined that process 25 should be completed at 42. That is, a complete combined partition elimination list has been provided, and is stored in the repository for further use in assisting the processing of query 15.

It will be recognized that sub-function 22 commences at “b” given that function 20 runs from “a” to “g”, which denote function sub-steps not shown explicitly in FIG. 3.

In some embodiments, rather than accumulating a complete list 8 in the first instance, each partition pair is used for accessing the database 2 on the fly. From a Massively Parallel Processing (MPP) perspective, building a list 8 is useful for inclusion in a step to be sent to the Access Module Processors (AMPs). Alternatively, the individual partition elimination lists could be sent to the AMPs and the AMPs could use the function to obtain the combined partitions pairs. This later method requires less space in the steps but more processing by the AMPs.

A practical example of how process 25 is implemented is provided below. Only selected portions of the complete execution are shown for the sake of conciseness. As discussed below, this example involves ninety-nine calls of function 20—only a few of these are shown. Specific instances of language—such as SQL—should not be regarded as limiting.

The following exemplary definition 3 is used:
CREATE TABLE pt (a int, p₁ int, p₂ int, p₃ int, p₄ int, d₁ int, d₂ int)
   PRIMARY INDEX (a)
   PARTITION BY (RANGE_N(p₁ BETWEEN 1 AND 20 EACH 1),
      RANGE_N(p₂ BETWEEN 1 AND 30 EACH 1),
      RANGE_N(p₃ BETWEEN 1 AND 15 EACH 1),
      RANGE_N(p₄ BETWEEN 1 AND 7 EACH 1));

The following exemplary query 15 is considered:
SELECT*FROM pₜ WHERE p₁ IN (4,5,6,12,13,14,19)
   AND p₂ IN (1,2,11,20,23,24,25)
   AND p₃ IN (7,8,9,10,14,15);

On the basis of this definition 3 and query 15, the following level specific inclusion lists 18 are obtained:
Level 1 (p₁): (4,6), (12,14), (19,19)
Level 2 (p₂): (1,2), (11,11), (20,20), (23,25)
Level 3 (p₃): (7,10), (14,15)
Level 4 (p₄): (1,7)

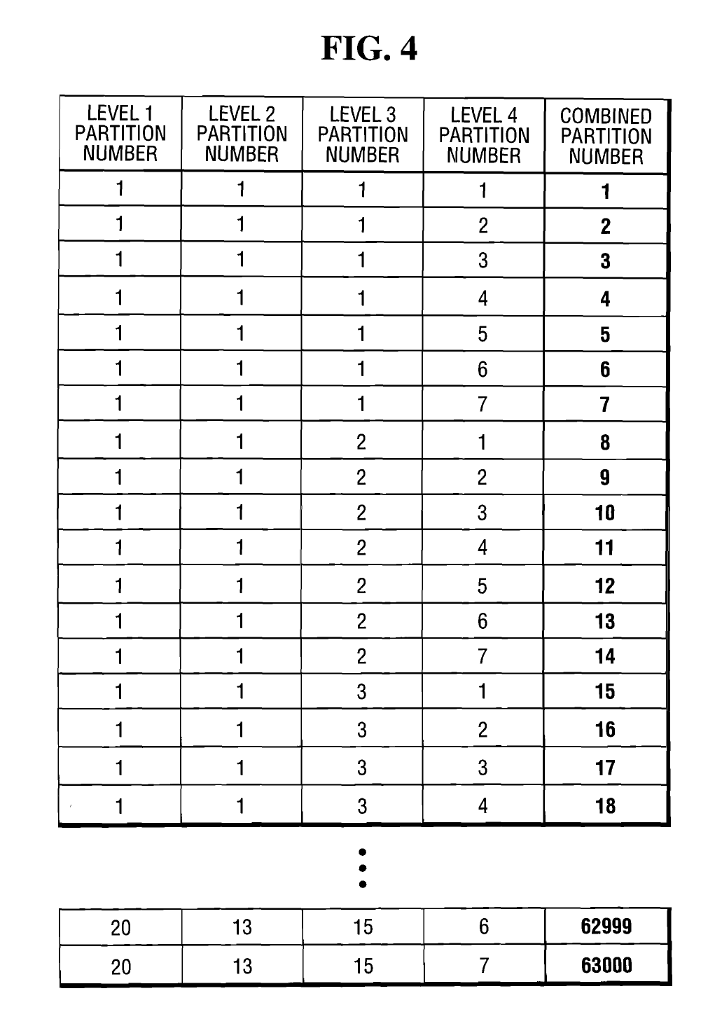

Also, for the sake of this example, combined partitions are numbered in accordance with the protocol described by reference to FIG. 2. A summary of a table showing these is provided in FIG. 4, and there are 63,000 combined partitions.

Working through phase 26:
There are 4 levels; therefore n is 4.
The number of partitions at each level provides that D₁ is 20, D₂ is 30, D₃ is 15, and D₄ is 7.
The number of combined contiguous partitions at each level provides that DD₄ is 1, DD₃ is 7, DD₂ is 105, and DD₁ is 3150.

For i=4, no partitions are eliminated (level 4 includes all partitions for that level). For i=3, some partitions are eliminated (level 3 does not include all partitions for that level). The ASP level is therefore set to 3. This loop exits.
The following tracking integers are defined:
   CPP₁ is 1. CPP₂ is 1. CPP₃ is 1.
   PP₁ is 3. PP₂ is 4. PP₃ is 2.
   CP₁ is 4. CP₂ is 1. CP₃ is 7.
   EP₁ is 6. EP₂ is 2. EP₃ is 10.

Function 20 is then called. On this first call, the following function state data 24 applies:
D₁ is 20. D₂ is 30. D₃ is 15. D₄ is 7.
DD₁ is 3150. DD₂ is 105. DD₃ is 7. DD₄ is 1.
CPP₁ is 1. CPP₂ is 1. CPP₃ is 1.
PP₁ is 3. PP₂ is 4. PP₃ is 2.
CP₁ is 4. CP₂ is 1. CP₃ is 7.
EP₁ is 6. EP₂ is 2. EP₃ is 10.
B is undefined.

Running sub-function 21, for i=ASP level, being 3, CP₃<=EP₃ (7<=10) so the loop is exited and sub-function 22 called. For this, i is set to the ASP level, which is 3. CPP₃ is 1, therefore, B is set to 1. For k=1 to (ASP level-1), that is, for k=1 to 2:
k=1: B is set to B+(CP₁−1)*DD₁, that is, 1+(4−1)*3150=9451.
k=2: B is set to B+(CP₂−1)*DD₂, that is, 9451+(1−1)*105=9451.

S is derived as (CP₃−1)*DD₃+B, that is, (7−1)*7+9451=9493.

E is derived as EP₃*DD₃+B−1, that is, 10*7+9451−1=9520.

CP₃ is set to EP₃+1, that is, 10+1=11.

The 1st partition pair provided is (S,E), that is, (9493,9520). Using a perhaps more transparent nomenclature, this is from p₁=4, p₂=6, p₃=7 to p₁=4, p₂=6, p₃=10, with p₄ cycling from 1 to 7 at each increment of p₃ from 6 to 10.

For the second call of function 20:
D₁ is 20. D₂ is 30. D₃ is 15. D₄ is 7.
DD₁ is 3150. DD₂ is 105. DD₃ is 7. DD₄ is 1.
CPP₁ is 1. CPP₂ is 1. CPP₃ is 1.
PP₁ is 3. PP₂ is 4. PP₃ is 2.
CP₁ is 4. CP₂ is 1. CP₃ is 11.
EP₁ is 6. EP₂ is 2. EP₃is 10.
B is 9451.

For i=3, CP₃ is not <=EP₃ (11 is not <=10), so the loop is not exited at this point. It will be recognized that setting CP₃ to EP₃+1 has this effect. This is used to cycle through pairs at the ASL level. CPP₃<PP₃ (1<2) so 1 is added to CPP₃, therefore, CPP₃ is set to 2. CP₃ is set 14 and EP₃ is set to 15 (the starting and ending partition numbers, respectively, of the partition pair indicated by CPP₃, that is, the second partition pair for level 3). The loop is exited.

Running sub-function 22, i is again set to 3. CPP₃ is not 1, therefore a new B is not calculated. This step ensures that the same value for B is used for each cycle through level 3 pairs. S is derived as (CP₃−1) * DD₃+B, that is, (14−1)*7+9451=9542. E is derived as EP₃*DD₃+B−1, that is, 15*7+9451−1=9555. CP₃ is set to EP₃+1, that is, 15+1=16. The 2nd partition pair is (S,E), that is, (9542,9555).

For the third call of function 20:
D₁ is 20. D₂ is 30. D₃ is 15. D₄ is 7.
DD₁ is 3150. DD₂ is 105. DD₃ is 7. DD₄ is 1.
CPP₁ is 1. CPP₂ is 1. CPP₃ is 2.
PP₁ is 3. PP₂ is 4. PP₃ is 2.
CP₁ is 4. CP₂ is 1. CP₃ is 16.
EP₁ is 6. EP₂ is 2. EP₃ is 15.
B is 9451.

For i=3, CP₃ is not <=EP₃ (16 is not <=15) the loop is not exited. CPP₃ is not <PP₃ (2 is not <2), so the loop is not exited at this stage either. i is not 1 (3 is not 1), so a null result is not returned. CPP₃ is then set to 1. CP₃ is set 7 and EP₃ is set to 10 (the starting and ending partition numbers, respectively, of the partition pair indicated by CPP₃, that is, the first partition pair for level 3). CP₂is set to 2.

The loop is repeated for i=2. CP₂<=EP₂ (2<=2) so the loop is exited.

Running sub-function 22, i is again set to ASP level, that is, 3. CPP₃ is 1, therefore, B is set to 1. For k=1 to 2, B becomes 9556. S is therefore derived as 9598. E is derived as 9625. CP₃ is set to EP₃+1, that is, 10+1=11. The 3rd partition pair is (S,E), that is, (9598,9625).

Function 20 is repeatedly called. For the 15^{th} call:
D₁ is 20. D₂ is 30. D₃ is 15. D₄ is 7.
DD₁ is 3150. DD₂ is 105. DD₃ is 7. DD₄ is 1.
CPP₁ is 1. CPP₂ is 4. CPP₃ is 2.
PP₁ is 3. PP₂ is 4. PP₃ is 2.
CP₁ is 4. CP₂ is 25. CP₃ is 16.
EP₁ is 6. EP₂ is 25. EP₃ is 15.
B is 11971.

For i=3, CP₃ is not <=EP₃ (16 is not <=15). CPP₃ is not <PP₃ (2 is not <2). i is not 1 (3 is not 1). CPP₃ is set to 1. CP₃ is set 7 and EP₃ is set to 10 (the starting and ending partition numbers, respectively, of the partition pair indicated by CPP₃, that is, the first partition pair for level 3). CP₂ is then set to 26.

For i=2, CP₂ is not <=EP₂ (26 is not <=25). CPP₂ is not <PP₂ (4 is not <4). i is not 1 (2 is not 1). CPP₂ is therefore set to 1. CP₂ is set 1 and EP₂ is set to 2 (the starting and ending partition numbers, respectively, of the partition pair indicated by CPP₃, that is, the first partition pair for level 2). CP₁ is then set to 5.

For i=1, CP₁ is <=EP₁ (5 is <=6) so exit loop. Running sub-function 22, i is set to 3. CPP₃ is 1, therefore B is set to 1. For k=1 to 2:
k=1: B is set to B+(CP₁−1)*DD1, that is, 1+(5−1)*3150=12601.
k=2: B is set to B+(CP₂−1)*DD2, that is, 12601+(1−1)*105=12601.

S is derived as 12643, and E is derived as 12670. CP₃ is set to EP₃+1, that is, 10+1=11. The 15th partition pair is (S,E), that is, (12643,12670).

Function 20 is called a further 83 times, providing 83 further combined partition pairs. During this time, sub function 21 progressively works through the possible combinations of level-specific partitions.

Finally, on the 99^{th} call:
D₁ is 20. D₂ is 30. D₃ is 15. D₄ is 7.
DD₁ is 3150. DD₂ is 105. DD₃ is 7. DD₄ is 1.
CPP₁ is 3. CPP₂ is 4. CPP₃ is 2.
PP₁ is 3. PP₂ is 4. PP₃ is 2.

CP₁ is 19. CP₂ is 25. CP₃ is 16.
EP₁ is 19. EP₂ is 25. EP₃ is 15.
B is 59221.

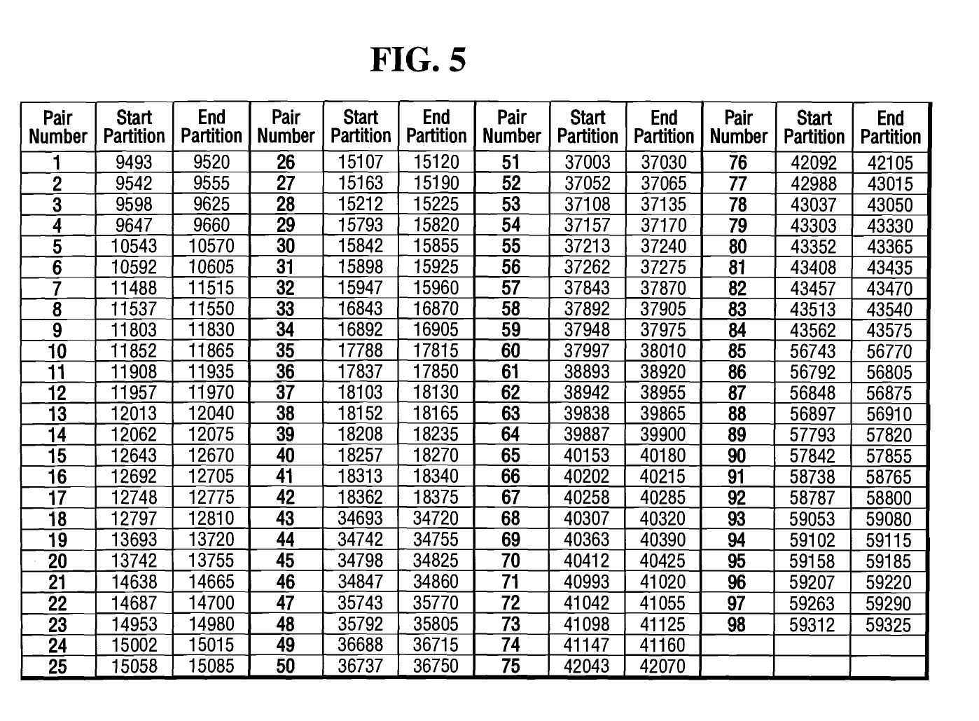

It will be recognized that the first loop will repeat to i=1. CP₁ is not <=EP₁ (20 is not <=19) so the loop is not exited. CPP₁ is not <PP₁ (3 is not <3). i is 1, so a null result is provided for the 99th call. 98 combined partition pairs have been provided, these 98 pairs defining list 8. FIG. 5 provides a table that shows all 98 pairs defining list 8 in this example.

Those skilled in the art will draw enough from the above example to understand and implement process 25 and exemplary function 20. This is designed to assist in the understanding of system 1.

It will be recognized that, in the provided example, system 1 identifies 2058 combined partitions required for execution of the exemplary query 15. This is out of 63,000 available combined partitions. This allows query 15 to be executed with greater efficiency than would otherwise be possible.

It will be appreciated that the embodiments of the present invention are alternately applied in relation to a generic multi-dimensional structure or representation that is mapped to a single-dimensional structure or representation. Those skilled in the art will recognize that such structures or representations are generally described by the term “partitioning”.

Although the present invention has been described with particular reference to certain preferred embodiments thereof, variations and modifications of the present invention can be effected within the spirit and scope of the following claims.

What is claimed is:

1. A partition elimination system for a database that uses a multi-level partitioning definition, the system including:
an interface for receiving data indicative of a plurality of level-specific elimination lists respectively associated with each level in the definition; and
a processor responsive to the data for providing a single combined partition elimination list.

2. A system according to claim 1 wherein the data is derived from partition elimination on the basis of a query that constrains on one or more level-specific partitions of the database.

3. A system according to claim 2 wherein each level-specific elimination list identifies one or more level-specific partitions on which the query constrains.

4. A system according to claim 3 wherein the combined partition elimination list identifies one or more combined partitions on which the query effectively constrains.

5. A system according to claim 1 either or both of the level-specific elimination lists and the single combined partition elimination list is an inclusive list.

6. A system according to claim 1 wherein for each level-specific partition in the definition there is defined a level-specific partition number and for each combination of individual partitions there is defined a combined partition number.

7. A system according to claim 6 wherein the combined partition number is defined on the basis of a predetermined protocol.

8. A system according to claim 7 wherein the predetermined protocol involves identifying combinations of the level-specific partition numbers and assigning in a logical order a unique combined partition number for each combination.

9. A system according to claim 6 wherein a unique combination of level-specific partition numbers is mappable to a unique combined partition number.

10. A system according to claim 1 wherein the processor repeatedly calls a function to identify a pair of combined partitions for inclusion in the combined elimination list, the pair defining a range of combined partitions.

11. A system according to claim 10 wherein the function is responsive to function state data.

12. A system according to claim 11 wherein the function modifies the function state data such that a unique result is provided each time the function is called, the unique result either being a unique pair for inclusion in the combined elimination list or a null result indicating that all unique pairs for inclusion in the combined elimination list have been previously identified.

13. A system according to claim 12 wherein the function includes an identification sub-function for identifying a unique combination of the level specific partitions identified by the level-specific elimination lists for a selection of the levels.

14. A system according to claim 13 wherein the selection of the levels is from the lowest level to the highest level for which the respective level-specific elimination list excludes one or more level-specific partitions.

15. A system according to claim 13 wherein each time the identification sub-function is called a unique and not previously considered combination is identified, the sub-function returning null once all unique combinations have been previously identified.

16. A system according to claim 15 wherein the combinations are identified in increasing combined partition order.

17. A system according to claim 15 wherein the unique combination is maintained in the data table.

18. A system according to claim 15 wherein the function includes a mapping sub-function, the mapping sub-function being responsive to the unique combination for identifying the pair of combined partitions.

19. A system according to claim 17 wherein the mapping function is responsive to the number of contiguous combined partitions for each level in the selection of levels.

20. A system according to claim 1 wherein the level-specific elimination lists provide a minimum selection of level-specific partition pairs and the combined elimination list provides a minimum selection of combined partition pairs.

21. A system according to claim 20 wherein the level-specific elimination lists provide level specific pairs in increasing order, and the combined elimination list provides combined partition pairs in increasing order.

22. A method for partition elimination in a database, the database using a multi-level partitioning definition, the method including the steps of:
receiving data indicative of a plurality of level-specific elimination lists respectively associated with each level in the definition; and
being responsive to the data for providing a single combined partition elimination list.

23. A combined partition elimination list for a database that uses a multi-level partitioning definition.
